(19) United States
(12) Patent Application Publication
(10) Pub. No.: US 2009/0247265 A1
(43) Pub. Date: Oct. 1, 2009

(54) SLOT MACHINE ENABLING PLAYER TO EASILY RECOGNIZE GAP FROM ANOTHER PLAYER IN TERMS REQUIRED BET AMOUNT IN GAME, AND PLAYING METHOD THEREOF

(75) Inventor: Fumiya Abe, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 12/233,105

(22) Filed: Sep. 18, 2008

Related U.S. Application Data
(60) Provisional application No. 61/041,337, filed on Apr. 1, 2008.

(51) Int. Cl. A63F 9/24; A63F 13/00

(52) U.S. Cl. 463/20; 463/25

(57) ABSTRACT

A slot machine, which runs a base game offering a chance of winning a payout according to a predetermined combination and a special game offering a chance of winning a higher payout than the base game, awards a payout according to the number of scatter symbols rearranged in an arrangement area of a matrix of one or more columns and one or more rows, runs the special game when a predetermined number or more of specific scatter symbols, among the rearranged scatter symbols, are rearranged, and sets a required bet amount of the special game run, according to the number of the specific scatter symbols rearranged.

### CROSS REFERENCE TO RELATED APPLICATION

The present application claims priority from provisional application No. 61/041,337, which was filed on Apr. 1, 2008, the entire disclosure of which is herein incorporated by reference.

### BACKGROUND OF THE INVENTION

1. Field of the Invention

The present invention relates to a slot machine and a playing method thereof.

2. Description of Related Art

In a known slot machine, when a player inserts a game medium such as coin or bill into an insertion slot of the slot machine and presses a spin button, symbols are scrolled in a display mounted on a front of a cabinet and then stopped automatically.

In such slot machine, as disclosed in U.S. Pat. No. 6,604,999B2 or U.S. Patent No. 2002065124A1, for example, when the symbols stopped on a payline form a predetermined combination, a predetermined number of game media are paid out. Further, a predetermined number of game media are paid out according to the number of symbols referred to as scatter symbols displayed on the display, irrespective of the payline.

In the known slot machine, when a predetermined condition is fulfilled, a feature game is run which puts a player in a more advantageous stage by offering a chance of winning a higher payout than a base game where the symbols are scrolled and stopped after a game medium is inserted. However, when a bet is required to play the feature game, the required bet amount is constant, i.e., not changed. Due to this, a player has a difficulty in recognizing whether s/he is in a better or worse position compared to another player.

An object of the invention is to provide a slot machine having an entertainment characteristic which is not brought about by the above mentioned prior art, and a playing method thereof.

Another object of the invention is to provide a slot machine enabling a player to easily recognize gap from another player in terms of a required bet amount on a feature game, and a playing method thereof.

### SUMMARY OF THE INVENTION

A slot machine of the present invention is a slot machine including: a base game offering a chance of winning a payout according to a predetermined combination; a special game offering a chance of winning a higher payout than the base game; a bet unit that receives a bet by a player; a display that has an arrangement area of a matrix having one or more rows and one or more columns, and arranges one or more scatter symbols the arrangement area; and a game controller which performs the steps of: (a1) rearranging the one or more scatter symbols in the arrangement area during the base game; (a2) awarding a payout according to the number of scatter symbols rearranged; (a3) running the special game when a predetermined number or more of specific scatter symbols among the rearranged scatter symbols are rearranged; and (a4) setting a required bet amount for the special game to be run, according to the number of specific scatter symbols rearranged.

(First Aspect)

According to the above structure, the special game is run when a predetermined number or more of specific scatter symbols, among the scatter symbols rearranged in the arrangement area of the matrix, are rearranged. Further, a required bet amount on the special game is set according to the number of specific scatter symbols rearranged. Hence, for example, the more the number of specific scatter symbols, the less the required bet amount of the special game. This removes the unfair feeling between a player who has more specific symbols rearranged and a player who has fewer specific symbols rearranged. Thus, a player is able to feel whether s/he is in a better/worse position compared to another player, in terms of bet amount. In addition to the gaming characteristic that the special game is run while enjoying the base game, it is possible to provide a player with the gaming characteristic that the required bet amount of the special game run is changed.

In the slot machine of the first aspect, the game controller may run the special game in which the required bet amount is set to 0, when a specified number or more of the specific scatter symbols are rearranged, the specified number being larger than the predetermined number.

(Second Aspect)

According to the above structure, when a specified number or more of the specific scatter symbols are rearranged, the specified number being larger than the predetermined number, the special game is run in which the required bet amount is set to zero. Hence, it is possible to enable a player to aim at a state in which the more specific scatter symbols are arranged, so that the gaming characteristic is more improved.

In the slot machine of the first aspect, the game controller may run the special game in which the required bet amount is set to zero, when the predetermined number or more of the specific scatter symbols are rearranged while being successively rearranged in a row direction of one row.

(Third Aspect)

According to the above structure, when the predetermined number or more of the specific scatter symbols are rearranged while being successively rearranged in one row in a row direction, the special game is run in which the required bet amount is set to zero. Hence, it is possible to enable a player to aim at a state in which the specific scatter symbols are successively arranged in a row direction, so that the gaming characteristic is more improved.

The slot machine of the first aspect may have a reset button that ends the special game being run, and the game controller may end the special game when the reset button is pressed.

(Fourth Aspect)

The above structure enables a player to press the reset button, thereby ending the special game run. Accordingly, the player is enabled to select whether to play the special game based on his/her determination. This enables the player to select a game more freely.

A slot machine of the present invention is a slot machine including: a base game offering a chance of winning a payout according to a predetermined combination; a special game offering a chance of winning a higher payout than the base game; a bet unit that receives a bet by a player; a display that has an arrangement area having a matrix of one or more rows and one or more columns and arranges one or more scatter symbols in the arrangement area; a reset button that ends the special game; and a game controller which performs the steps of: (b1) rearranging the one or more scatter symbols in the arrangement area during the base game; (b2) awarding a payout according to the number of scatter symbols rearranged; (b3) running the special game when a predetermined number or more of specific scatter symbols, among the rearranged scatter symbols, are rearranged; (b4) setting a required bet amount of the special game run, according to the number of the specific scatter symbols rearranged; (b5) setting the required bet amount to zero, when a specified number or more of the specific scatter symbols are rearranged, the specified number being larger than the predetermined number, or when the predetermined number or more of the specific scatter symbols are rearranged while being successively rearranged in a row direction of one row; and (b6) ending the special game run, when the reset button is pressed.

(Fifth Aspect)

According to the above structure, the special game is run when a predetermined number or more of specific scatter symbols, among the scatter symbols rearranged in the arrangement area of the matrix, are rearranged. Further, a required bet amount of the special game is set according to the number of the specific scatter symbols rearranged. Hence, for example, the more the number of specific scatter symbols, the less the required bet amount of the special game. This removes the unfair feeling between a player who has more specific symbols rearranged and a player who has fewer specific symbols rearranged. Thus, a player is able to feel whether s/he is in a better/worse position compared to another player, in terms of bet amount. In addition to the gaming characteristic that the special game is run while the player is enjoying the base game, it is possible to provide a player with the gaming characteristic that the required bet amount of the special game run is changed. Further, when a predetermined number or more of the specific scatter symbols are rearranged, the predetermined number being larger than the predetermined number, the special game is run in which the required bet amount is set to zero. Hence, it is possible to enable a player to aim at a state in which the more specific scatter symbols are arranged, so that the gaming characteristic is more improved. Furthermore, when the predetermined number or more of the specific scatter symbols are rearranged while being successively rearranged in one row in a row direction, the special game is run in which the required bet amount is set to zero. Hence, it is possible to enable a player to aim at a state in which the specific scatter symbols are successively arranged in a row direction, so that the gaming characteristic is more improved. In addition, a player can press the reset button, thereby ending the special game run. Accordingly, the player is enabled to select whether to play the special game based on his/her determination. This enables the player to select a game more freely.

A playing method of a slot machine, which machine includes a base game offering a chance of winning a payout according to a predetermined combination; a special game offering a chance of winning a higher payout than the base game; a bet unit that receives a bet by a player; and a display that has an arrangement area having a matrix of one or more rows and one or more columns and arranges one or more scatter symbols in the arrangement area; the playing method including the steps of: (c1) rearranging the one or more scatter symbols in the arrangement area during the base game; (c2) awarding a payout according to the number of scatter symbols rearranged; (c3) running the special game when a predetermined number or more of specific scatter symbols, among the rearranged scatter symbols, are rearranged; and (c4) setting a required bet amount of the special game run, according to the number of the specific scatter symbols rearranged.

(Sixth Aspect)

According to the above structure, the special game is run when a predetermined number or more of specific scatter symbols, among the scatter symbols rearranged in the arrangement area of the matrix, are rearranged. Further, a required bet amount of the special game is set according to the number of the specific scatter symbols rearranged. Hence, for example, the more the number of specific scatter symbols, the less the required bet amount of the special game. This removes the unfair feeling between a player who has more specific symbols rearranged and a player who has fewer specific symbols rearranged. Thus, a player is able to feel whether s/he is in a better/worse position compared to another player, in terms of bet amount. In addition to the gaming characteristic that the special game is run while the player is enjoying the base game, it is possible to provide a player with the gaming characteristic that the required bet amount of the special game run is changed.

### BRIEF DESCRIPTION OF THE DRAWINGS

FIG. 1 is an explanatory diagram illustrating a slot machine and a playing method thereof, according to the present invention.

FIG. 2 is a block diagram of the slot machine.

FIG. 3 is an explanatory diagram illustrating a display state of a central display when shifting to a basic feature game from a basic game.

FIG. 4 is an explanatory diagram illustrating a display state of a central display when shifting to a special feature game from a basic game.

FIG. 5 is an explanatory diagram illustrating a symbol column of scatter symbols rearranged on a central display.

FIG. 6 is a perspective view illustrating an external appearance of the slot machine.

FIG. 7 is a block diagram showing an electrical structure of a slot machine.

FIG. 8 is a flowchart showing a boot process routine that is executed in a slot machine.

FIG. 9 is a flowchart showing an initial process routine that is executed in a slot machine.

FIG. 10 is a flowchart showing a basic game running process routine that is executed in a slot machine.

FIG. 11 is a flowchart showing a feature game running process routine that is executed in a slot machine.

FIG. 12 is a flowchart showing a self reset process routine that is executed in a slot machine.

FIG. 13 is a flowchart showing a count reset process routine that is executed in a slot machine.

FIG. 14 is a flowchart showing a player changing reset process routine that is executed in a slot machine.

### DESCRIPTION OF THE PREFERRED EMBODIMENTS

The following describes an embodiment of a slot machine and a playing method thereof according to the present invention.

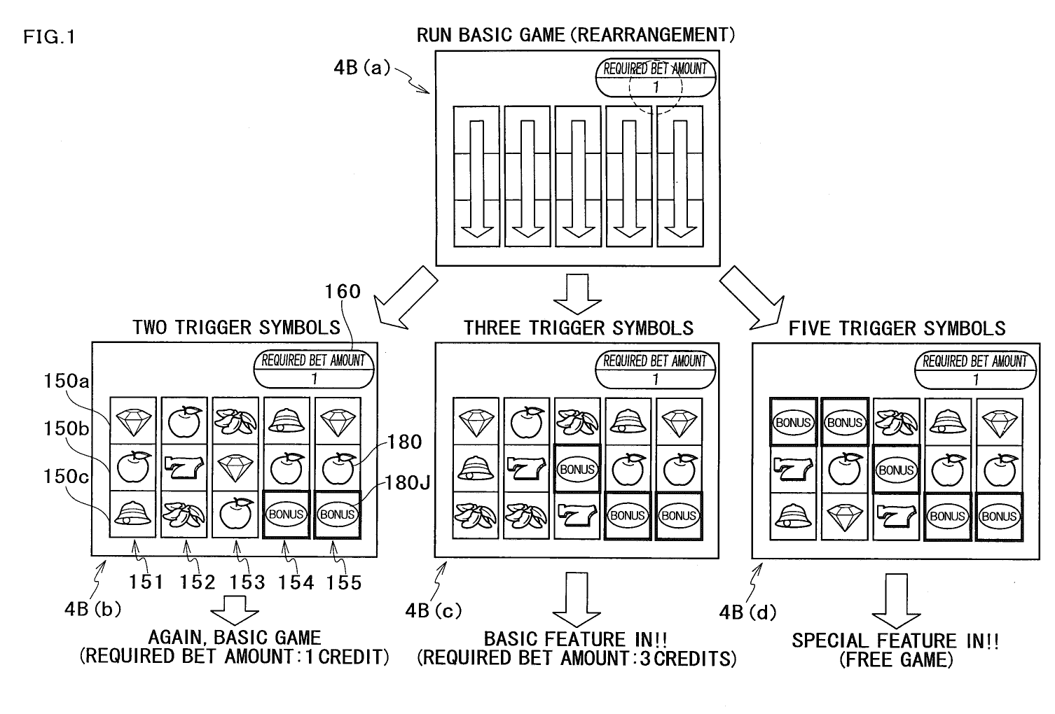

As shown in FIG. 1, a slot machine 1 of the present invention executes a playing method including the steps of: rearranging scatter symbols 180 in symbol arrangement areas 151 to 155 during a basic game; awarding a payout according to the number of scatter symbols 180 rearranged; running a feature game, when a predetermined number (for example, three) or more of trigger symbols 180J, among the rearranged scatter symbols 180, are rearranged; and setting a required bet amount of the feature game run, according to the number of the trigger symbols 180J rearranged.

The “arrangement” in this specification means a state where the scatter symbols 180 including the trigger symbols 180J can be visually observed by a player. In short, the wording means the scatter symbols 180 displayed in the symbol arrangement areas 151 to 155. Arranging the scatter symbols 180 again after dismissing them is referred to as “rearranging”. The symbol arrangement areas 151 to 155 will be described later.

Each of the “scatter symbols” is a symbol whose arrangement could result in a winning irrespective of a pay line L. Appearance of a predetermined number (for example, three) of scatter symbols in the symbol arrangement areas 151 to 155 gives an advantage to a player. For example, the advantages includes: a state where coins corresponding to the scatter symbols 180 arranged are paid out, a state where the number of coins to be paid out is added to a credit, a state where a feature game is started.

Each of the “trigger symbols 180” is a symbol that is included in the scatter symbols 180. Appearance of a predetermined number (for example, three) or more of trigger symbols in the symbol arrangement areas 151 to 155 runs a feature game. In the present embodiment, a symbol of “BONUS” is used as the trigger symbol 180J. However, the invention is not limited thereto.

A “basic game” in this specification is a game in which scatter symbols 180 are rearranged in the symbol arrangement areas 151 to 155 and a payout is awarded when a winning is formed according to a relation of the base symbols 180 rearranged. The basic game is run under base state. In the present embodiment, the basic game has a required bet amount of “one credit.” That is, when a player inserts one coin corresponding to one credit in the slot machine 1, the player can play the basic game.

The “feature game” is a so-called bonus game in which the higher payout than the basic game is awarded to a player and a superiority degree of the payout to a player is higher than the basic game. Further, the feature game is run when a predetermined number (for example, three) or more of the trigger symbols 180J, among the scatter symbols 180 arranged in the symbol arrangement areas 151 to 155, are rearranged. Moreover, in the present embodiment, the feature game is divided into two types, i.e., a basic feature game and a special feature game. The shifting to the basic feature game from the basic game is referred to as basic feature IN and the shifting to the special feature game from the basic game is referred to as special feature IN. The basic feature IN and the special feature IN are collectively referred to as feature IN.

The “basic feature game” is a feature game that is run when three or four trigger symbols 180J are arranged in the symbol arrangement areas 151 to 155 in a basic game. The basic feature game that is run when the three trigger symbols 180J are arranged has a required bet amount of “three credits.” The basic feature game that is run when the four trigger symbols 180J are arranged has a required bet amount of “two credits.” As described above, the shifting to the basic feature game from the basic game is referred to as basic feature IN.

The “special feature game” is a feature game that is run when five trigger symbols 180J are arranged in the symbol arrangement areas 151 to 155 or three or more trigger symbols 180J are successively rearranged in a row direction, in a basic game. The special feature game is a free game and has a required bet amount of “0 credit.” Accordingly, the special feature game is a game that is most advantageous to a player. As described above, the shifting to the special feature game from the basic game is referred to as special feature IN.

The “required bet amount” is a minimum bet amount that is necessary for a player to play a game in the “basic game” and the “feature game.”

For example, in FIG. 1, the scatter symbols 180 are rearranged in the symbol arrangement areas 151 to 155 of a central display 4B by a player's operation, so that a basic game is run (refer to 4B(a)). The central display 4B will be described later.

In addition, when there are two symbols of “BONUS”, which are the trigger symbols 180J arranged in the symbol arrangement areas 151 to 155 (refer to 4B(b)), a basic game is run without shifting to the feature IN. In this case, the required bet amount remains one credit.

When the three trigger symbols 180J are arranged in the symbol arrangement areas 151 to 155 (refer to 4B(c)), a basic feature IN is formed, so that a basic feature game is run. In this case, since the basic feature IN is formed under state that the three trigger symbols 180J are arranged, the required bet amount is set to “three credits.” For example, when the basic feature IN is formed under state the four trigger symbols 180J are arranged, the required bet amount is set to “two credits.”

In addition, when the five trigger symbols 180J are arranged in the symbol arrangement areas 151 to 155 (refer to 4B(d)), a special feature IN is formed, so that a special feature game is run. This is a free game, and the required bet amount is set to “zero credit.”

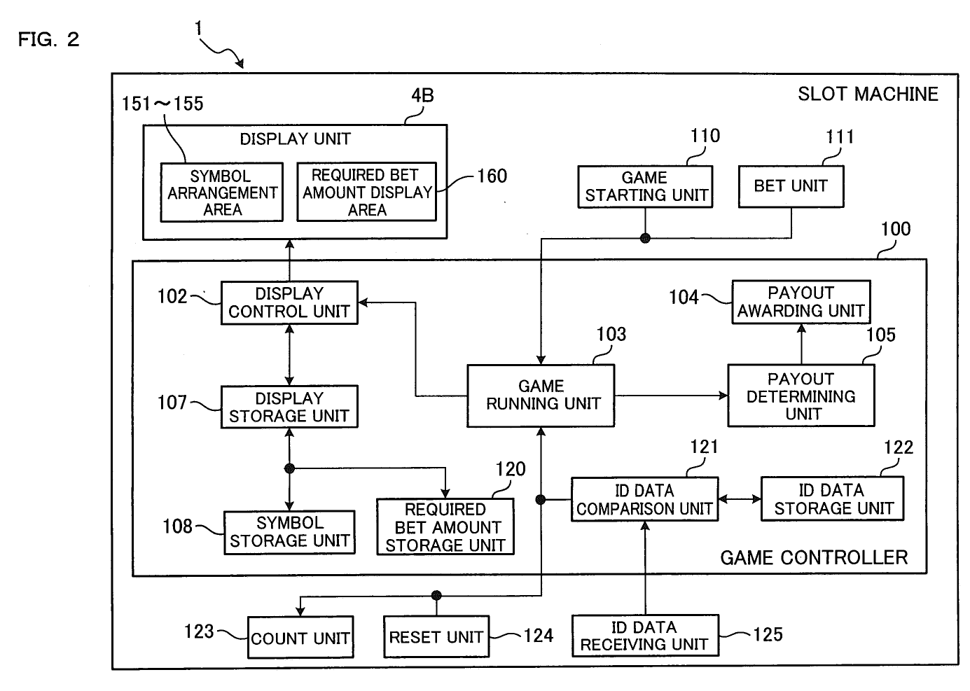

As shown in FIG. 2, the slot machine 1 executing the playing method has a central display 4B and a game controller 100.

(Central Display 4B)

The central display 4B serving as a display unit has the symbol arrangement areas 151 to 155 and a required bet amount display area 160, as shown in FIG. 1.

The symbol arrange areas 151 to 155 are areas in which the scatter symbols 180 are arranged in the central display 4B and divided into an upper stage 150a, a middle stage 150b and a lower stage 150c, respectively. The required bet amount display area 160 is an area in which required bet amounts in the basic and feature games are displayed. The area is displayed in a right top of the central display 4B.

In the present embodiment, the “row” means a horizontal symbol column of the symbol arrangement areas 151 to 155 having a matrix, and the “column” means a vertical symbol column of the symbol arrangement areas 151 to 155 having a matrix. The “column direction” is a scroll direction of the scatter symbols 180 and the “row direction” is a direction perpendicular to the scroll direction of the scatter symbols 180. In short, the symbol arrangement areas 151 to 155 having a matrix of 3 rows/5 columns.

The central display 4B may have a mechanical structure adopting a reel device which rotates a reel to arrange the scatter symbols 180. Alternatively, the central display 4B may have an electric structure in which a video reel is displayed as an image, and the symbols on the video reel are arranged in the form of an image. Further, the central display 4B may adopt a combination of the mechanical structure (reel) and the electrical structure (video reel). Examples of the electrical structure include a liquid crystal display device, a CRT (cathode-ray tube), a plasma display device, or the like. The number of the symbol arrangement areas 151 to 155 is not particularly limited. A specific display state of the central display 4B will be described below.

(Game Controller 100)

The game controller 100 is structured to execute a playing method including: a first process of rearranging scatter symbols 180 in symbol arrangement areas 151 to 155; a second process of awarding a payout according to the number of the scatter symbols 180 rearranged; a third process of running a feature game when a predetermined number (for example, 3) or more of trigger symbols 180J, among the rearranged scatter symbols 180, are rearranged; and a fourth process of setting a required bet amount of the feature game run, according to the number of the trigger symbols 180J rearranged.

In addition, the game controller 100 is structured to execute a fifth process of running a special feature game in which the required bet amount is set to zero, when a specified number (for example, five) or more of the trigger symbols 180J are rearranged, the specified number being larger than the predetermined number (for example, 3).

In addition, the game controller 100 is structured to execute a sixth process of running a special feature game in which a required bet amount is set to zero, when the predetermined number (for example, three) or more of the trigger symbols 180J are arranged while being successively rearranged in a row direction of one row in the symbol arrangement areas 151 to 155.

Further, the game controller 100 is structured to execute a seventh process of ending the feature game run, when a reset button 310 of the slot machine 1 is pressed. In other words, the terminal controller 100 has first to seventh processing units.

As shown in FIG. 2, the game controller 100 is connected to a game starting unit 110, a bet unit 111, a count unit 123, a reset unit 124 and an ID data receiving unit 125.

The game starting unit 110 has a function of outputting a game start signal, in response to an operation by the player. The game start signal output is then input to a later-detailed game running unit 103.

The BET unit 111 has functions of receiving a bet entered through an operation by the player, and outputting a BET signal. The BET signal output is input to the later-detailed game running unit 103.

The count unit 123 starts or stops timing, under control of a later-detailed game running unit 103.

The reset unit 124 outputs a reset button pressed signal to a later-detailed game running unit 103 when a later-detailed reset button 310 is pressed by a player.

When an ID card 300 is inserted into a later-detailed card reader 15 of the slot machine 1, the ID data receiving unit 125 reads out and receives ID data from the ID card 300. In addition, the ID card receiving unit also has a function of detecting that the ID card 300 is removed from the card reader 15 and the ID data is read out (discharged). When the ID card 300 is inserted into the card reader 15, the ID data receiving unit 125 outputs an input signal to an ID data comparison unit 121. When the ID card 300 is removed from the card reader 15, the ID data receiving unit 125 outputs a discharge signal to the ID data comparison unit 121.

The “ID card 300” is possessed by each player and is a storage medium that stores the ID data allotted to each player, data about game history played by a player and the like. In this embodiment, a game can be run only when the ID card 300 is inserted into the card reader 15 and the ID data is received. In this embodiment, the “ID data” is identification data that is allotted to each of players so as to identify a player.

In addition, the game controller 100 includes an ID data storage unit 122 and an ID data comparison unit 121.

The ID data storage unit 122 stores ID data that is stored in the ID card 300 inserted into the ID data receiving unit 125. In short, the ID data storage unit 122 stores the ID data of a player who plays a game with the slot machine 1.

The ID data comparison unit 121 stores the ID data newly inputted from the ID data receiving unit 125 in the ID data storage unit 122, based on an ID data input signal from the ID data receiving unit 125. In addition, the ID data comparison unit 121 compares the newly inputted ID data with the original ID data stored in the ID data storage unit 122. As a result, when both ID data are not identical to each other, the ID data comparison unit outputs an ID data-inappropriate signal to a later-detailed game running unit 103. In response to the ID data discharge signal received from the ID data receiving unit 125, the ID data comparison unit 121 deletes the ID data stored in the ID data storage unit 122.

The game controller 100 includes: a symbol storage unit 108, a required bet amount storage unit 120, a display storage unit 107, a display control unit 102 and a game running unit 103.

The symbol storage unit 108 stores the scatter symbols 180. The required bet amount storage unit 120 stores required bet amounts in the basic game, the basic feature game and the special feature game.

The display storage unit 107 stores, as scatter symbols 180 to be displayed, the scatter symbols 180 in the symbol storage unit 108. In addition, the display storage unit 107 stores, as required bet amounts to be displayed, the required bet amounts in the bet amount storage unit 120.

Further, the display control unit 102 reads out scatter symbols 180 to be displayed from the display storage unit 107 and displays the scatter symbols 180 in the symbol arrangement areas 151 to 155, under control of the game running unit 103. In addition, under control of the game running unit 103, the display control unit 102 reads out the required bet amount to be displayed from the display storage unit 107 and displays the required bet amount in the required bet amount display area 160.

The game running unit 103 runs a basic game, triggered by the game start signal from the game starting unit 110. The basic game is a game in which scatter symbols 180 are rearranged in the symbol arrangement areas 151 to 155 of the central display 4B. Further, when a predetermined number or more trigger symbols 180J, among the scatter symbols 180 arranged in the symbol arrangement areas 151 to 155, are arranged, the game running unit 103 runs a feature game.

Moreover, the game running unit 103 sets a required bet amount in a basic game, according to the number of the trigger symbols 180J arranged in the symbol arrangement areas 151 to 155, the arranged location and the like. To be more specific, when three trigger symbols 180J are arranged in the symbol arrangement areas 151 to 155, the game running unit 103 runs a basic feature game in which the required bet amount is set to “3 credits.” When four trigger symbols 180J are arranged in the symbol arrangement areas 151 to 155, the game running unit 103 runs a basic feature game in which the required bet amount is set to “2 credits.” Further, when five or more trigger symbols 180J are arranged, the game running unit 103 runs a special feature game in which the required bet amount is set to “0 credit.” Moreover, when three or more trigger symbols 180J are arranged while being successively arranged in a row direction, the game running unit runs a special feature game in which the required bet amount is set to “zero credit.” The game running unit 103 causes the display control unit 102 to display the required bet amount set on the bet amount display area 160.

In addition, in response to the ID data-inappropriate signal received from the ID data comparison unit 121 during the feature game, the game running unit 103 ends the feature game that is being run.

In response to the reset button pressed signal received from the reset unit 124 during the feature game, the game running unit 103 ends the feature game that is being run.

When running the feature game, the game running unit 103 causes the count unit 123 to start timing. After a predetermined period of time (for example, 10 minutes) for which the count unit 123 times, the game running unit ends the feature game that is being run. When a game start signal is received from the game starting unit 110 in a predetermined period of time after the count unit 123 has started timing, the game running unit causes the count unit 123 to stop timing.

The game controller 100 includes a payout determining unit 105 and a payout award unit 104.

The payout determining unit 105, under control of the game running unit 103, determines whether to award payouts of a basic game and a feature game on the basis of a relation of the scatter symbols 180 rearranged in the symbol arrangement areas 151 to 155. When it is determined that a combination is formed, the payout determining unit 105 determines a payout amount and outputs a signal to the payout award unit 104.

The payout award unit 104 awards the payouts of the basic game and the feature game, based on the determination of the payout determining unit 105.

Meanwhile, each block of the game controller 100 may be realized with hardware or with software as needed.

(Operation of Game Controller 100)

The following describes an operation of the game controller 100 in the above structure. First, the BET unit 111 receives a BET entered through an operation by a player. Further, a game start signal is output from the game starting unit 110 in response to the player's operation, and a basic game is run by the game running unit 103. When the basic game is run, the display control unit 102, under control of the game running unit 103, displays scatter symbols 180 in the symbol arrangement areas 151 to 155. Like this, the game controller 100 performs the first process of rearranging the scatter symbols 180 in the symbol arrangement areas 151 to 155.

Further, the payout determining unit 105 determines whether the basic game has resulted in a winning, based on a relation among the scatter symbols 180 rearranged in the symbol arrangement areas 151 to 155. When it is determined that the basic game has resulted in a winning, the payout determining unit 105 determines a payout amount. The payout of the basic game thus determined is awarded by the payout award unit 104. Like this, the game controller 100 performs the second process of awarding a payout according to the number of scatter symbols 180 rearranged.

Further, in the basic game, when a predetermined number (for example, three) or more of the trigger symbols 180J, among the scatter symbols 180 arranged in the symbol arrangement areas 151 to 155, are arranged, the game running unit runs a feature game. Like this, the game controller 100 performs the third process of running a feature game when a predetermined number (for example, three) or more of trigger symbols 180J, among the rearranged scatter symbols 180, are rearranged.

Moreover, in the basic game, the game running unit 103 sets a required bet amount according to the number of scatter symbols 180 arranged in the symbol arrangement areas 151 to 155, the arranged location and the like. In addition, at this time, the display control unit 102 displays the required bet amount set on the required bet amount display area 160. Like this, the game controller 100 performs the fourth process of setting a required bet amount of the feature game run, according to the number of the trigger symbols 180J rearranged.

Meantime, when the game running unit 103 sets a required bet amount, if five trigger symbols 180J are arranged in the symbol arrangement areas 151 to 155, a special feature game is run in which the required bet amount is set to “0 credit.” Like this, the game controller 100 performs the fifth process of running a special feature game in which the required bet amount is set to 0, when a specified number (for example, 5) or more of the trigger symbols 180J are rearranged, the specified number being larger than the predetermined number (for example, 3).

Further, when a required bet amount is set, if the three or more trigger symbols 180J are arranged in the symbol arrangement areas 151 to 155 while being successively rearranged in a row direction, the game running unit 103 runs a special feature game in which a required bet amount is set to “0 credit.” Like this, the game controller 100 performs the sixth process of running a special feature game in which a required bet amount is set to 0, when the predetermined number (for example, three) or more of the trigger symbols 180J are arranged while being successively rearranged in a row direction of one row in the symbol arrangement areas 151 to 155.

In addition, when a player presses a later-detailed reset button 310 while the feature game is being run, the reset unit 124 outputs a reset button pressed signal to the game running unit 103. Afterwards, the game running unit 103 having received the reset button pressed signal ends the feature game that is being run. Like this, the game controller 100 performs the seventh process of ending the feature game run, when a reset button 310 of the slot machine 1 is pressed.

As is obvious from the above operations, the slot machine 1 realizes a playing method including the steps of: rearranging scatter symbols 180 in symbol arrangement areas 151 to 155; awarding a payout according to the number of scatter symbols 180 rearranged; running a feature game, when a predetermined number or more of trigger symbols 180J, among the rearranged scatter symbols 180, are rearranged; and setting a required bet amount of the feature game run, according to the number of the trigger symbols 180J rearranged.

According to the above playing method, the feature game is run when a predetermined number or more of trigger symbols 180J, among the scatter symbols 180 rearranged in the symbol arrangement areas 151 to 155 of the matrix, are rearranged. Further, a required bet amount of the feature game is set according to the number of the trigger symbols 180J rearranged. Hence, for example, the more the number of trigger symbols 180J, the less the required bet amount of the feature game. This removes the unfair reeling between a player who has more trigger symbols 180J rearranged and a player who has fewer trigger symbols 180J rearranged. Thus, a player is able to feel whether s/he is in a better/worse position compared to another player, in terms of bet amount. In addition to the gaming characteristic that the feature game is run while the player is enjoying the basic game, it is possible to provide a player with the gaming characteristic that the required bet amount of the feature game run is changed.

In addition, the slot machine 1 realizes the playing method including the step of running the special feature game in which the required bet amount is set to 0, when a specified number or more of the trigger symbols 180J are rearranged, the specified number being larger than the predetermined number.

According to the playing method, when a specified number or more of the trigger symbols 180J are rearranged, the specified number being larger than the predetermined number, a special feature game is run in which the required bet amount is set to 0. Hence, it is possible to enable a player to aim at a state in which the more trigger symbols 180J are arranged, so that the gaming characteristic is more improved.

Further, the slot machine 1 realizes the playing method including the step of running the special feature game in which the required bet amount is set to 0, when the predetermined number or more of the trigger symbols 180J are rearranged while being successively rearranged in a row direction of one row in the symbol arrangement areas 151 to 155.

According to the playing method, when the predetermined number or more of the trigger symbols 180J are rearranged while being successively rearranged in a row direction of one row, the special feature game is run in which the required bet amount is set to 0. Hence, it is possible to enable a player to aim at a state in which the trigger symbols 180J are successively arranged in a row direction, so that the gaming characteristic is more improved.

Moreover, the slot machine 1 realizes the playing method including the step of ending the feature game run, when a later-detailed reset button 310 of the slot machine 1 is pressed.

The above playing method enables a player to press the reset button 310, thereby ending the feature game run. Accordingly, the player is enabled to select whether to play the feature game based on his/her determination. This enables the player to select a game more freely.

(Display State of Central Display 4B)

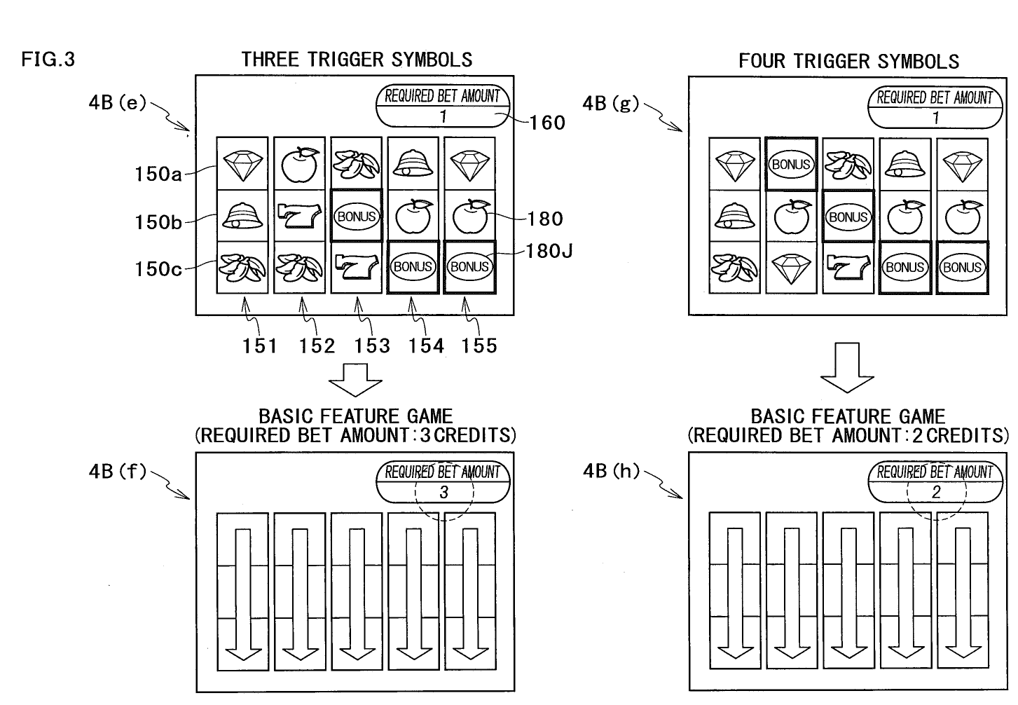

The following details an exemplary display state of the central display 4B during the operations of the slot machine 1 and the playing method thereof. Note that the following example deals with a case where the central display 4B adopts a video reel and arranges the scatter symbols 180 on a video reel in the form of an image, as illustrated in FIG. 3.

As shown in FIG. 3, the central display 4B has the symbol arrangement areas 151 to 155 for arranging the scatter symbols 180. The symbol columns consisting of the scatter symbols 180 are scrolled in the symbol arrangement areas 151 to 155. In addition, each of the symbol arrangement areas 151 to 155 is divided into an upper stage 150a, a middle stage 150b and a lower stage 150c. The scatter symbols 180 are stopped (arranged) in each of the stages 150a, 150b, 150c, respectively. For example, in FIG. 3, a symbol of “DIAMOND” is stopped in the upper stage 150a of the symbol arrangement area 151, a symbol of “BELL” is stopped in the middle stage 150b of the symbol arrangement area 151 and a symbol of “BANANA” is stopped in the lower stage 150c of the symbol arrangement area 151. (refer to 4B(e)). Hence, the symbol arrangement areas 151 to 155 display a symbol matrix of five columns/three rows. In the meantime, the symbol matrix is not limited to five columns/three rows.

In the present embodiment, when a predetermined number (for example, three) or more of the scatter symbols 180 having a same type are displayed in the symbol matrix, a process of paying out coins and the like is performed. However, for example, a process may be adopted in which payline L crossing the middle stages 150b of the respective symbol arrangement areas 151 to 155 are provided and coins and the like are paid out when the scatter symbols 180 stopped on the paylines L constitute a predetermined combination.

Further, the required bet amount display area 160 is displayed in the right top of the central display 4B. The area displays a required bet amount of a game that is currently played by a player. Thus, it is possible to enable a player to play a game while seeing the required bet amount of a game that is played by the player.

The central display 4B(e) shown in the left top of FIG. 3 displays that the three trigger symbols 180J are arranged in the symbol arrangement areas 151 to 155. In this case, a basic feature IN is formed in a next rearrangement step of the scatter symbols 180, so that a basic feature game is run. In addition, the required bet amount at that time is set to “three credits” (refer to 4B(f)).

In addition, the central display 4B(g) shown in the right top of FIG. 3 displays that the four trigger symbols 180J are arranged in the symbol arrangement areas 151 to 155. Also in this case, likewise the case where the three trigger symbols 180J are arranged, a basic feature IN is formed in a next rearrangement step of the scatter symbols 180, so that a basic feature game is run. However, the required bet amount at that time is set to “two credits” (refer to 4B(f)). That is, in the cases where three and four trigger symbols 180J are arranged, respectively, the required bet amount is changed. In addition, the basic feature game in the case where the four trigger symbols 180J are arranged is set in such a manner that it is advantageous to a player.

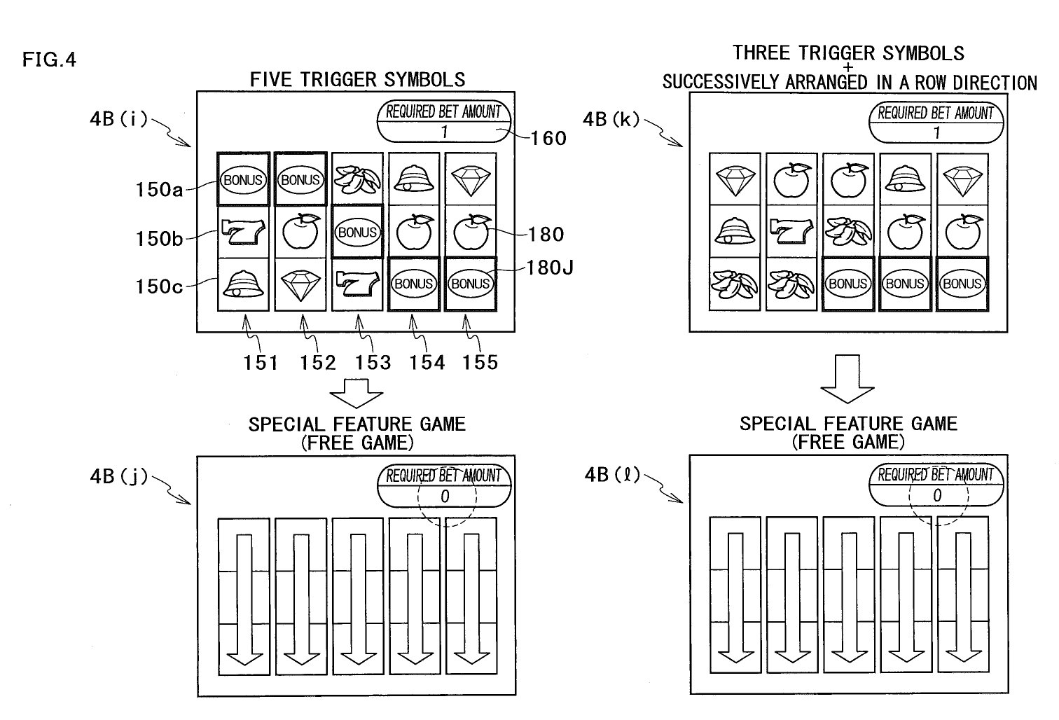

Then, the central display 4B(i) shown in the left top of FIG. 4 displays that the five trigger symbols 180J are arranged in the symbol arrangement areas 151 to 155. In this case, a special feature IN is formed in a next rearrangement step of the scatter symbols 180, so that a special feature game is run. In addition, the required bet amount at that time is set to “zero credit” (refer to 4B(j)). That is, the special feature game becomes a free game, which is a feature game that is most advantageous to a player.

In addition, the central display 4B(k) shown in the right top of FIG. 4 displays that the three trigger symbols 180J are arranged in the symbol arrangement areas 151 to 155 At this time, the three trigger symbols 180J are successively arranged in a row direction in the lower stage 150c. In this case, likewise the case where the five trigger symbols 180J are arranged, a special feature IN, not the basic feature IN, is formed in a next rearrangement step of the scatter symbols 180, so that a special feature game is run (refer to 4B(1)). That is, when the three trigger symbols 180J are arranged, a basic game is typically run. However, since the scatter symbols 180J are also successively arranged in a row direction of one row (upper stage 150a, middle stage 150b, lower stage 150c) in the symbol arrangement areas 151 to 155, a special feature game is run and the gaming state becomes thus a free game.

(Symbol, Combination, or the Like)

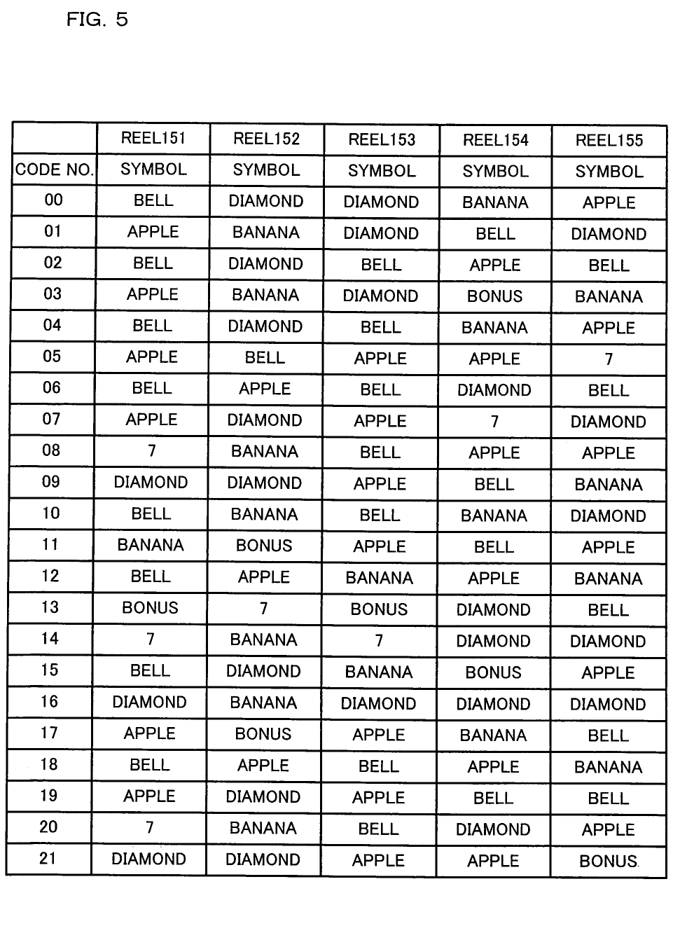

As shown in FIG. 5, the scatter symbols 180 including the trigger symbols 180J displayed in the symbol arrangement areas 151 to 155 of the central display 4B constitute a symbol column by 22 symbols. To each of the symbols constituting the columns is given one of code numbers 0 to 21. Each of the symbol columns consists of a symbol combination of “BELL,” “APPLE,” “DIAMOND,” and “BONUS” that is the trigger symbol 180J.

Of the symbols in the symbol columns, the symbol arrangement areas 151 to 155 each displays (arranges) three successive scatter symbols 180. The symbols arranged in the upper stage 150a, the middle stage 150b, and the lower stage 150c form a symbol matrix having five columns and three rows. When a bet button and a start button are then pressed to start a game, scatter symbols 180 constituting the symbol matrix start to scroll. This scrolling of the symbols stops (rearrangement) after a predetermined period from the beginning of the scrolling.

In addition, when a predetermined number or more scatter symbols 180 having a same type are displayed in the symbol arrangement areas 151 to 155, an advantageous state is given to a player. For example, the advantageous state includes: a state where coins corresponding to the scatter symbols are paid out, a state where the number of coins to be paid out is added to a credit, a state where a bonus game is started and the like.

To be more specific, when three or more scatter symbols 180 having a same type are rearranged in the symbol arrangement areas 151 to 155, twenty coins (game media) are paid out for one bet. In addition, when a predetermined number (for example, three) or more of the trigger symbols 180J are rearranged, a feature game trigger is made, so that the gaming state is shifted to a feature game from a basic game.

As described above, the feature game is a gaming state that is more advantageous to a player than the basic game. Meantime, another feature game may be adopted together as long as it is advantageous to a player, i.e., it is more advantageous than the basic game. For example, another feature game may include: a state where more game media can be obtained that in the basic game, a state where the game media can be obtained in a higher probability than the basic game, a state where less game media are consumed that in the basic game, and the like.

(Mechanical Structure of Slot Machine 1)

Next, the following describes a specific example of mechanical and electrical structures of the slot machine 1 thus structured.

A slot machine 1 is placed in a gaming facility such as a casino. This slot machine 1 runs a unit game with a game medium. The game medium is a coin, bill, or a value in the form of electronic information. However, the game medium in the present invention is not particularly limited. For example, a medal, token, electronic money, ticket or the like are also possible. Further, the ticket is not particularly limited and may be a later-detailed ticket with a barcode or the like ticket.

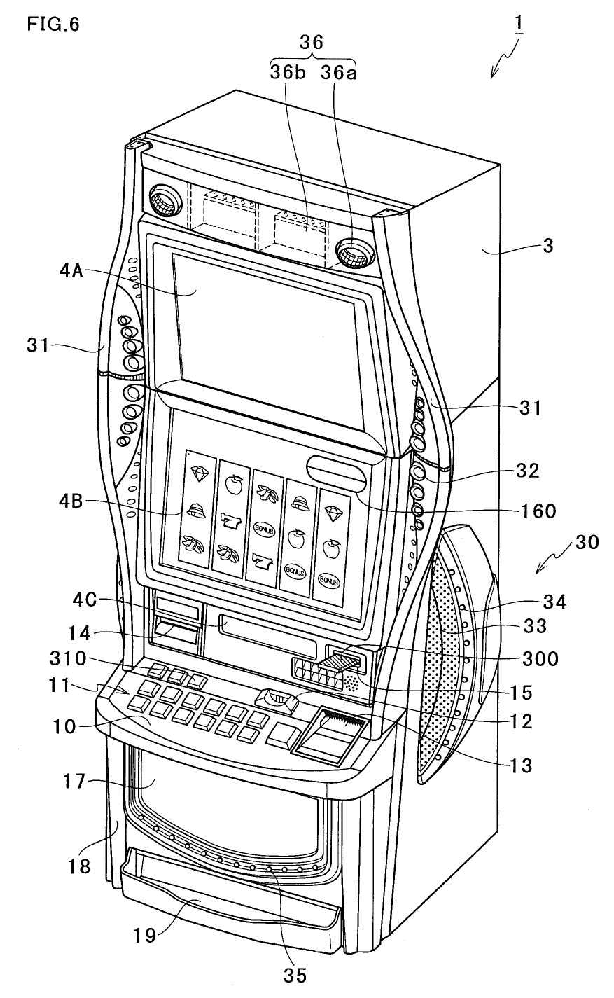

As shown in FIG. 6, the slot machine 1 is an upright-type slot machine and has a cabinet 3 for receiving therein electrical or mechanical parts for running a predetermined game aspect. The upper display 4A, the central display 4B and the lower display 4C serve as a display for displaying the game information based on operations by a player. Each of the displays 4A to 4C is mounted to the front of the cabinet 3 that is vertically long.

The upper display 4A displays an effect image, an image indicating the introduction of game contents, the game rules, and the like.

The central display 5B is a display displaying rotating symbols where five symbol arrangement areas 151 to 155 are displayed, on which a player always fixes the eyes. When a winning is formed, an effect such as moving picture is performed in the central display 5B. Further, the right top of the central display 4B displays the required bet display area 160.

The lower display 5C displays points or game points recorded in the ID card 300. The numerical value displayed in the lower display 4C is based on the display result of the central display 4B. When a winning is formed in the central display 4B, the game points displayed in the lower display 4C are added on the basis of the winning formed. To a left of the lower display 4C is provided a ticket printer 14. To a right of the lower display 4C is provided a card reader 15 for inserting or removing the ID card 300. The winning means a state in which the three or more scatter symbols 180 having a same type are rearranged and various kinds of payouts are thus paid out.

Below the lower display 4C is provided an operation table 10 that forward protrudes from the front of the cabinet 3. The operation table 10 disposes thereon operation buttons 11 (for example, spin button, change button, cashout button, 1-bet button, maximum bet button and the like) with which a player plays a game. The operation table 10 also disposes thereon a reset button 310 with which a player ends the feature game run. Further, the operation table 10 is provided with a coin insertion slot 12 and a bill insertion slot 13.

Below the operation table 10 is disposed a waist panel 17. The waist panel 17 is a plastic panel having a game-related image printed thereon. The waist panel 17 is fixed to a lower front door 18 and illuminated by a cold cathode-ray tube. A coin receiving portion 19 that collects coins, which are paid out on the basis of a game result, is disposed below the waist-position panel 19.

In addition, lamps 30 are disposed to the cabinet 3 of the slot machine 1 so that they surround a game area including the upper display 4A, the central display 4B, the lower display 4C and the operation table 10. The lamps 30 includes side lamps 22 that are provided to inclined parts 31, which are protruded in a bow shape at front right and left ends of the cabinet 3 and at side parts over the upper display 4A, the central display 4B and the lower display 4C, speaker lamps 34 that are provided to arc-shaped speakers 23, which are sideway protruded at the right and left ends of the cabinet 3 adjacent to the operation table 10, and are disposed along edges of the speakers 33, under lamps 24 that are provided to the lower front door 18 and disposed along lower edges of the waist-position panel 17, and top lamps 36 that are provided above the upper display 4A and have power lamps 36a disposed at both sides and central band-shaped lamps 26b disposed in a horizontal direction.

(Electrical Structure of Slot Machine 1)

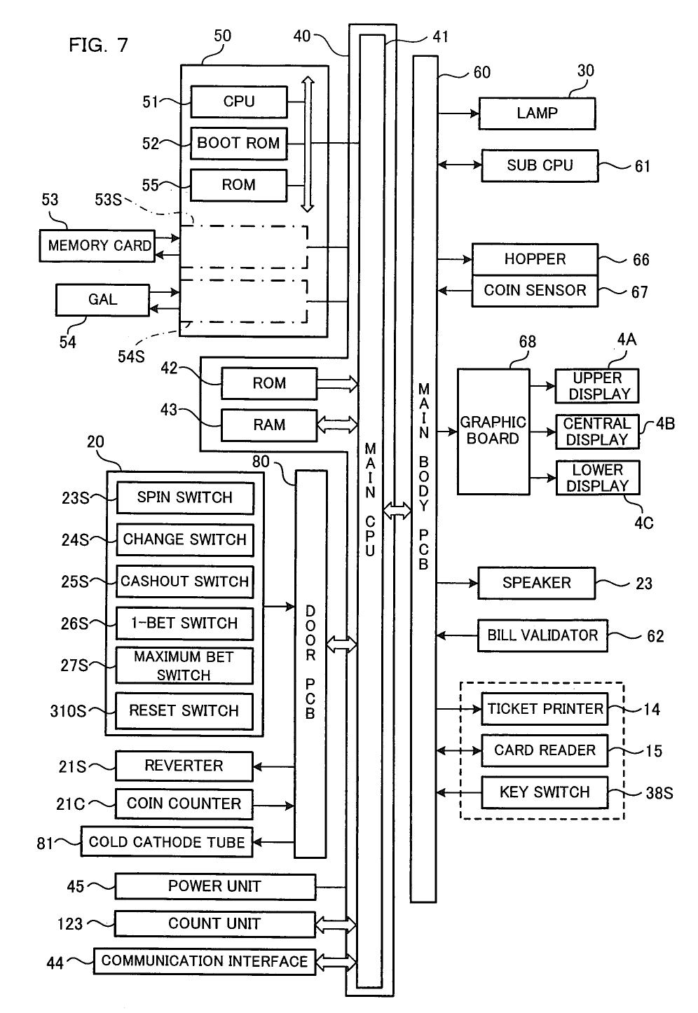

FIG. 7 is a block diagram showing an electrical structure of the slot machine 1. As illustrated in FIG. 7, the cabinet 3 includes therein a control unit having a game controller 100. The control unit includes a motherboard 40, a main body PCB (Printed Circuit Board) 60, a gaming board 50, a door PCB 80, various switches, sensors, or the like.

The gaming board 50 is provided with a CPU (Central Processing Unit) 51, a ROM 55, a boot ROM 52, a card slot 53S corresponding to a memory card 53, and an IC socket 54S corresponding to a GAL (Generic Array Logic) 54. The CPU 51, the ROM 55, and the boot ROM 52 are connected to one another through an internal bus.

The memory card 53 stores therein a game program and a game system program. The game program contains a stop symbol determining program. The symbol determining program is for determining scatter symbols 180 (code numbers corresponding to the symbols) to be stopped in the symbol arrangement areas 151 to 155. This stop symbol determining program contains sets of symbol weighting data respectively corresponding to various payout rates (e.g., 80%, 84%, 88%). Each set of the symbol weighting data indicates, for each of the symbol arrangement areas 151 to 155, a corresponding relation between a code number of each scatter symbol 180 and at least one random numerical value within a predetermined range of 0 to 256, for example.

The payout rate is determined based on payout rate setting data output from the GAL 54. Based on a set of the symbol weighting data corresponding to the payout rate determined, a symbol to be stopped is determined.

The memory card 53 stores therein various types of data for use in the game programs and the game system programs. For example, the data indicating a relation between a scatter symbol 180 to be displayed on the symbol arrangement areas 151 to 155 of FIG. 3 and a random numerical value is stored as a table format. This data is transferred to the RAM 43 of the motherboard 40, at the time of running a game program.

The card slot 53S is structured so as to allow the memory card 53 to be attached/detached to/from the card slot 53S. This card slot 53S is connected to the motherboard 40 through an IDE bus. Thus, the type and content of a game run by a slot machine 1 can be modified by detaching the memory card 53 from the card slot 53S, writing a different game program and a different game system program into the memory card 53, and then inserting the memory card 53 back into the card slot 53S.

Each of the game programs includes a program related to the progress of the game and/or a program for causing a transition to a feature game. Each of the game programs includes image data and audio data output during the game.

The GAL 54 has input and output ports. When the GAL 54 receives data via the input port, it outputs data corresponding to the input data from its output port. This data from the output port is the payout rate setting data described above.

IC socket 54S is structured so as to allow the GAL 54 to be attached/detached to/from the IC socket 54S. The IC socket 54S is connected to the motherboard 40, via a PCI bus. Thus, the payout rate setting data to be output from GAL 54 can be modified by: detaching the GAL 54 from the IC socket 54S, overwriting the program stored in the GAL 54, and attaching the GAL 54 back to the IC socket 54S.

The CPU 51, the ROM 55 and the boot ROM 52 connected through an internal bus are connected to the motherboard 40 through the PCI bus. The PCI bus communicates signals between the motherboard 40 and the gaming board 50 and supplies power from the motherboard 40 to the gaming board 50. The ROM 55 stores country identification information and an authentication program. The boot ROM 52 stores a preliminary authentication program and a program (boot code) for enabling the CPU 51 to run the preliminary authentication program.

The authentication program is a program (falsification check program) for authenticating the game program and the game system program. The authentication program is a program for confirming and verifying that the game program and the game system program are not falsified. In other words, the authentication program is described in accordance with a procedure for authenticating the game program and the game system program. The preliminary authentication program is a program for authenticating the authentication program. The preliminary authentication program is described in accordance with a procedure for verifying that the authentication program to be authenticated is not falsified. In short, the preliminary authentication program authenticates the authentication program.

The motherboard 40 is provided with a main CPU 41 (game controller 100), a ROM (Read Only Memory) 42, and a RAM (Random Access Memory) 43.

The main CPU 41 serves as a game controller 100 and has a function of controlling the entire slot terminal 10. In particular, the main CPU 41 controls the following operations: an operation of outputting a signal instructing variable-displaying of scatter symbols 180 to the graphic board 68, which is performed in response to pressing of the spin button after betting of credit; an operation of determining scatter symbols 180 to be stopped after the variable-displaying of scatter symbols 180; and an operation of stopping the scatter symbols 180 thus determined in the symbol arrangement areas 151 to 155.

In other words, the main CPU 41 serves as an arrangement controller which arranges symbols to form a new symbol matrix through scrolling of scatter symbols 180 displayed on the central display 4B. This main CPU 41 therefore determines symbols to be arranged in a symbol matrix by selecting symbols to be arranged from various kinds of scatter symbols 180. Then, the main CPU 41 executes arrangement control to stop scrolling the symbols to present the scatter symbols 180 thus determined.

In addition, the main CPU 41 serves as the game controller 100 that executes a first process of rearranging scatter symbols 180 in symbol arrangement areas 151 to 155; a second process of awarding a payout according to the number of the scatter symbols 180 rearranged; a third process of running a feature game when a predetermined number (for example, 3) or more of trigger symbols 180J, among the rearranged scatter symbols 180, are rearranged; a fourth process of setting a required bet amount of the feature game run, according to the number of trigger symbols 180J rearranged; a fifth process of running a special feature game in which a required bet amount is set to 0, when a specified number or more of the trigger symbols 180J are rearranged, the specified number being larger than the predetermined number; a sixth process of running a special feature game in which a required bet amount is set to 0, when the predetermined number or more of the trigger symbols 180J are arranged while being successively rearranged in a row direction of one row in the symbol arrangement areas 151 to 155; and a seventh process of ending the feature game run, when a reset button 310 of the slot machine 1 is pressed. The main CPU 41 serves as: the game running unit 103 of FIG. 2, the display control unit 102, the payout determining unit 105, the payout award unit 104 and the ID data comparison unit 121.

The ROM 42 stores a program such as BIOS (Basic Input/Output System) run by the main CPU 41, and permanently-used data. When the BIOS is run by the main CPU 41, each of peripheral devices is initialized and the game program and the game system program stored in the memory card 53 are read out through the gaming board 50.

The RAM 43 stores data or a program used for the main CPU 41 to perform a process. For example, RAM 43 has the symbol storage unit 108, the required bet amount storage unit 120, the display storage unit 107 and the ID data storage unit 122 of FIG. 2, in the form of data area. Then, in the data area of the symbol storage unit 108 are stored the scatter symbols 180J. In the data area of the required bet amount storage unit 120 are stored the required bet amounts of the basic game and the feature game. In the data area of the display storage unit 107 are stored the scatter symbols to be displayed and the required bet amounts to be displayed. In the data area of the ID data storage unit 122 are stored the ID data of players.

Further, the main CPU 41 is connected to a communication interface 44. The communication interface 44 is provided to communicate with a host computer and the like equipped in the gaming facility, through the network (communication line). Further, the main CPU 41 is connected to a count unit 123. The count unit 123 is for timing, under control of the main CPU 41. Further, a main body PCB (Printed Circuit Board) 60 and a door PCB 80 are connected to the motherboard 40, through a USB (Universal Serial Bus). Further, the motherboard 40 is connected to a power unit 45. The power unit 45 supplies power to the motherboard 40 to boot the main CPU 41 thereof. Meanwhile, the power unit 45 supplies power to the gaming board 50 through the PCI bus to boot the CPU 51 thereof.

The main body PCB 60 and door PCB 80 are connected to various devices or units which generate signals to be input to the main CPU 41, and various devices or units whose operations are controlled by signals from the main CPU 41. Based on a signal input to the main CPU 41, the main CPU 41 runs the game program and the game system program stored in the RAM 43, to perform an arithmetic process. Then, the CPU 41 stores the result of the arithmetic process in the RAM 43, or transmits a control signal to the various devices and units to control them based on the result.

The main body PCB 60 is connected to the lamps 30 (specifically, side lamps 32, speaker lamps 34, under lamps 35 and top lamps 36), a sub CPU 61, a hopper 66, a coin sensor 67, a graphic board 68, speakers 33, a bill validator 62, a ticket printer 14, a card reader 15 and a key switch 38S.

The lamp 30 is turned on/off on the basis of a control signal from the main CPU 41.

The sub CPU 61 controls the scrolling of the scatter symbols 180 in the symbol arrangement areas 151 to 155 and is connected to a later-detailed VDP (Video Display Processor). The VDP reads out image data of the scatter symbols 180 stored in the RAM 43, generates a scroll image to be displayed in the symbol arrangement areas 151 to 155 and outputs the scroll image to the central display 5B.

The hopper 66 is mounted in the cabinet 3 and pays out a predetermined number of coins from a coin outlet to the coin receiving portion 19, based on a control signal outputted from the main CPU 41. The coin sensor 67 is provided inside the coin outlet, and outputs a signal to be inputted to the main CPU 41 upon sensing that a predetermined number of coins have been paid out from the coin outlet.

The graphic board 68 controls the image display in the upper display 4A, the central display 4B and the lower display 4C, based on a control signal outputted from the main CPU 41. Further, the graphic board 68 is provided with the VDP for generating image data on the basis of a control signal from the main CPU 41, a video RAM for temporarily storing the image data generated by the VDP, or the like. Note that image data used at the time of generating the image data by the VDP is read out from the memory card 53 and then stored in the RAM 43.

The bill validator 62 reads an image of bill inserted into the bill insertion slot 13 and receives therein the genuine bill. When the genuine bill is received, the bill validator 62 outputs an input signal indicating the value of the bill to the main CPU 41. The main CPU 41 stores into the RAM 43 a credit-value corresponding to the value of the bill indicated by the input signal.

The ticket printer 35 prints a barcode on to a ticket to issue a ticket 39 having the barcode, based on a control signal from the main CPU 41. The barcode contains encoded data such as credit-value stored in the RAM 43, date and time, identification number of the slot machine 1, or the like,.

The card reader 15 detects that the ID card 300 possessed by each player is inserted or removed, and reads out and receives the ID data when the ID card 300 is inserted. In addition, when the ID data is received, the card reader 36 transmits a signal to the main CPU 41. Moreover, the card reader 36 writes data to the ID card 300, based on a control signal from the main CPU 41. In short, the card reader 36 serves as the ID data receiving unit 125 of FIG. 2. The key switch 38S is mounted to a keypad (not shown), and outputs an input signal to the main CPU 41 in response to an operation of the keypad by the player.

The door PCB 80 is connected to a control panel 20, a reverter 21S, a coin counter 21C, and a cold cathode tube 81. The control panel 20 is provided with: a change switch 24S associated with the change button 24; a cashout switch 25S associated with the cashout button 25; and a maximum bet switch 27S associated with the maximum bet button. Each of the switches 24S, 25S, 27S outputs an input signal to the main CPU 41, when a player presses the associated one of the buttons.

Further, the door PCB 80 is provided with a spin switch 23S associated with the spin button. The spin switch 23S outputs a game start signal to the main CPU 41, when a player presses the spin button. In short, the spin switch 23S serves as the game starting unit 110 of FIG. 2.

In addition, the door PCB 80 is provided with a 1-bet switch 26S associated with the 1-bet button. The 1-bet switch 26S receives a player's operation and outputs a bet signal to the main CPU 41. In short, the 1-bet switch 26S serves as the bet unit 111 of FIG. 2.

Further, the door PCB 80 is provided with a reset switch 310S associated with the reset button 310. The reset switch 310S outputs a reset pressed signal to the main CPU 41, when a player presses the reset button 310. In short, the reset switch 310S serves as the reset unit 124 of FIG. 2.

The coin counter 21C is provided within the coin insertion slot 21, and identifies whether the coin inserted into the coin insertion slot 12 by the player is genuine. A coin except the genuine coin is discharged from the coin outlet 19. In addition, the coin counter 21C outputs an input signal to the main CPU 41 upon detection of a genuine coin.

The reverter 21S is operated on the basis of the control signal output from the main CPU 41 and distributes a coin, which is recognized as a genuine coin by the coin counter 21C, to a not-illustrated cash box or hopper 66 mounted in the slot machine 1. In other words, when the hopper 66 is full of the coins, the genuine coin is distributed into the cash box by the reverter 21S. On the other hand, when the hopper 66 is not yet full with the coins, the genuine coin is distributed into the hopper 66. The cold cathode tube 81 functions as a backlight mounted to rear sides of the upper display 4A and the central display 4B. The cold cathode tube 81 turns on according to a control signal from the main CPU 41.

(Process Routine of Slot Machine 1: Boot Process Routine)

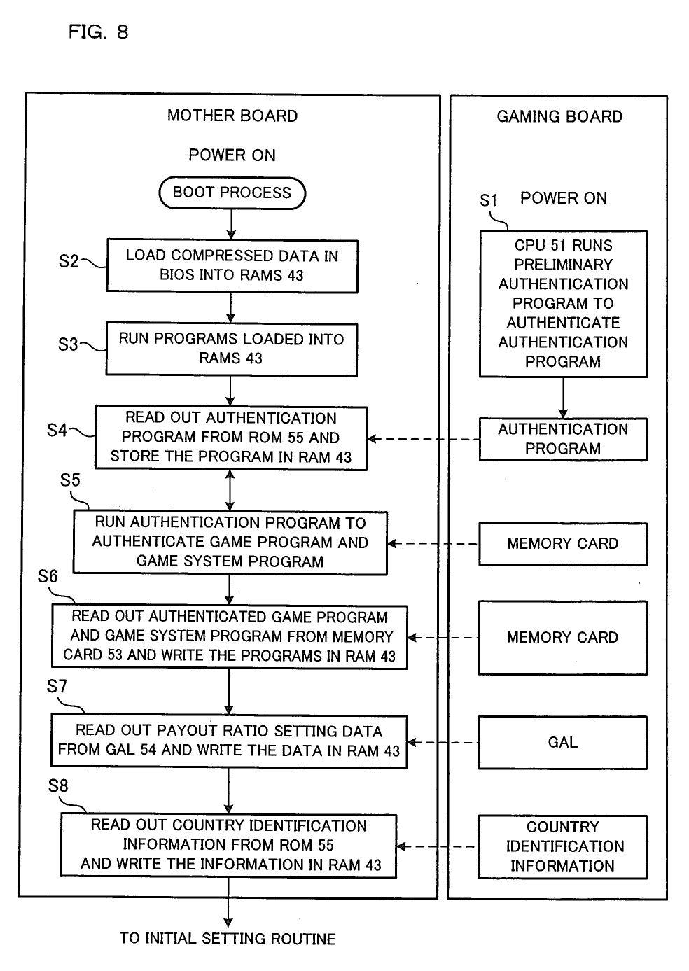

The following describes a boot process routine that is executed in the slot machine 1. Upon powering on the slot machine 1, a boot process routine of FIG. 8 starts in the motherboard 40 and the gaming board 50 of the game controller 100. The memory card 53 is assumed to be inserted into the card slots 53S of the gaming board 50. Further, the GAL 54 is assumed to be attached to the IC socket 54S.

First, turning on the power switch of (powering on) the power unit 45 boots the motherboard 40 and the gaming board 50. Booting the motherboard 40 and the gaming board 50 starts separate processes in parallel. Specifically, in the gaming board 50, the CPU 51 reads out a preliminary authentication program stored in the boot ROM 52. Then, preliminary authentication is performed according to the read out program so as to confirm and authenticate that no modification is made to the authentication program, before reading them in the motherboard 40 (S1). Meanwhile, the main CPU 41 of the motherboard 40 runs BIOS stored in the ROM 42 to load into the RAM 43 compressed data built in the BIOS (S2). Then, the main CPU 41 runs a procedure of the BIOS according to the data loaded into the RAM 43 so as to diagnose and initialize various peripheral devices (S3).

The main CPU 41, which is connected to the ROM 55of the gaming board 50 via a PCI bus, reads out the authentication program stored in the ROM 55 and stores it in the RAM 43 (S4). During this step, the main CPU 41 derives a checksum through ADDSUM method (a standard check function) which is adopted in a standard BIOS, and store the authentication program into RAM 43 while confirming if the operation of storing is carried out without an error.

Next, the main CPU 41 checks what connects to the IDE bus. Then, the main CPU 41accesses, via the IDE bus, to the memory card 53 inserted into the card slot 53S, and reads out a game program and a game system program from the memory card 53. In this case, the main CPU 41 reads out four bytes of data constituting the game program and the game system program at one time. Next, with the authentication program stored in the RAM 43, the main CPU 41 authenticates the game program and the game system program read out to confirm and prove that the programs are not modified (S5).

When the authentication properly ends, the main CPU 41 writes and stores the authenticated game program and game system program in the RAM 43 (S6).

Next, the main CPU 41 accesses, via the PCI bus, to the GAL 54 attached to the IC socket 54S, and reads out payout rate setting data from the GAL 54. The payout rate setting data read out is then written and stored in the RAM 43 (S7).

Next, the main CPU 41 reads out, via the PCI bus, country identification information stored in the ROM 55 of the gaming board 50. The country identification information read out is then stored in the RAM 43 (S8).

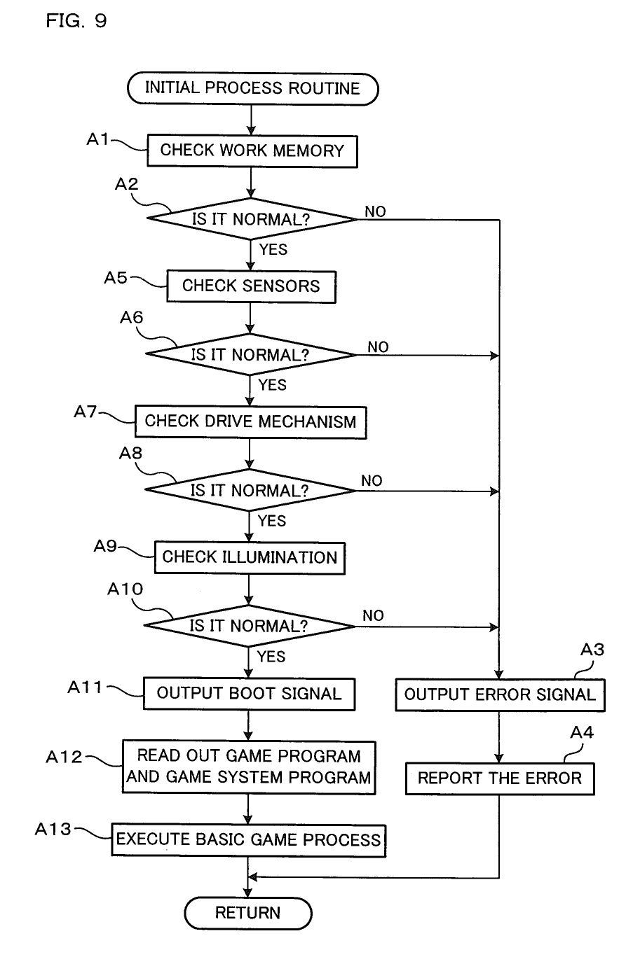

After this, the main CPU 41 performs an initial process of FIG. 9.

(Process Routine of Slot Machine 1: Initial Process Routine)

The following describes an initial process routine that is executed in the slot machine 1. When the boot process of FIG. 8 is completed, the slot machine 1 reads out from the RAM 243 an initial process routine illustrated in FIG. 9 and executes the routine.

First, the main CPU 41 of the slot machine 1 checks operations of a work memory such as RAM 43 (A1). Then, the main CPU 41 determines if all the check results are normal (A2). When the main CPU 41 determines that the check results contain an error (A2: NO), the main CPU 41 outputs a signal notifying the error (hereinafter, error signal) to the host computer (A3) Further, the main CPU 41 reports the error in the form of illuminating the lamps 30 or the like (A4), and then ends the routine.

On the other hand, when the main CPU 41 determines that the check results are all normal (A2: YES), the main CPU 41 checks operations of various sensors (A5). Then, the main CPU 41 determines if all the check results are normal (A6). When the main CPU 41 determines the check results contain an error (A6: NO), the main CPU 41 executes A3.

On the other hand, when the main CPU 41 determines in A6 that the check results are all normal (A6: YES), the main CPU 41 checks operations of various drive mechanisms (A7). Then, the main CPU 41 determines if all the check results are normal (A8). When the main CPU 41 determines the check results contain an error (A8: NO), the main CPU 241 executes A3.

On the other hand, when the main CPU 41 determines in A8 that the check results are all normal (A8: YES), the main CPU 41 checks operations of various illuminations (A9). Then, the main CPU 41 determines if all the check results are normal (A10). When the main CPU 41 determines the check results contain an error (A10: NO), the main CPU 41 executes A3.

After the checking operations through the steps A1 to A10 for checking operations of various functions, when the main CPU 41 determines in A10 that the check results are all normal (A10: YES), the main CPU 41 outputs a boot signal (A11). Afterwards, the main CPU reads out the game program and the game system program from the RAM 43 (A12), executes a basic game process (A13) and ends this routine.

(Process Routine of Slot Machine 1: Basic Game Running Process Routine)

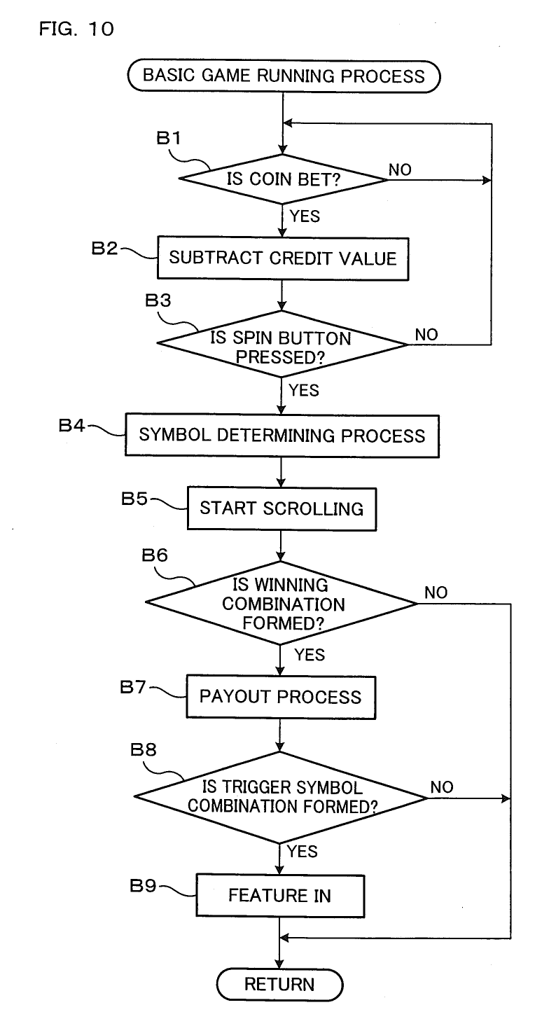

When the initial process routine of FIG. 9 is completed, the main CPU 41 executes a basic game running process routine shown in FIG. 10. The main CPU 41 executes the basic game running process routine, thereby running a basic game.

As shown in FIG. 10, in the basic game running process routine, the main CPU determines whether a player bets a coin or not (B1). In this step, it is determined whether abet signal from the 1-bet switch 26S entered by pressing the 1-bet button is received. Meanwhile, it is determined whether an input signal from the maximum bet switch 27S entered by pressing the maximum bet button is received. When no coin is BET (B1: NO), B1 is repeated until a coin is bet.

On the other hand, when a coin is bet (B1: YES), the credit value stored in the RAM 43 is reduced according to the number of coins bet (B2). When the number of coins bet surpasses the credit value stored in the RAM 43, the process goes to B3 without the reduction of the credit value. When the number of coins bet exceeds the maximum number of coins bettable in one game (50 pieces in this embodiment), the process goes to a later-detailed step B3 without the reduction of the credit value.

Then, the main CPU determines whether the spin button is ON (pressed) or not (B3). When the spin button is not pressed (B3: NO), the process returns to B1. On the other hand, when the spin button is not ON (pressed) (for example, the spin button 23 is not pressed but a command to end the game is inputted), the reduction of the credit value in B2 is canceled.

On the other hand, when the spin button is pressed (B3: YES), a symbol determining process is executed (B4). In short, the stop symbol determining program stored in the RAM 43 is executed to determine the scatter symbols 180 to be stopped in the symbol arrangement areas 151 to 155. Hence, a combination of scatter symbols 180 to be stopped in the symbol arrangement areas 151 to 155 is determined.

Afterwards, a scrolling process is executed to scroll the scatter symbols in the central display 4B at the same time (B5). The scrolling process is a process in which the scatter symbols 180 determined in B4 are stopped (rearranged) after scrolling the scatter symbols 180 in an upward/downward direction.

Next, the main CPU determines whether the scatter symbols 180 rearranged in the symbol arrangement areas 151 to 155 form a winning combination (B6). When it is determined that a winning combination is not formed (B6: NO), this routine ends.

On the other hand, when it is determined in B6 that a winning combination is formed (B6: YES), a payout process is executed (B7). That is, a payout-value of coins related to the number of scatter symbols 180 having a same type is calculated. When the coins to be paid out are stored, a predetermined number of credits are added to the credit-value stored in the RAM 43. On the other hand, when the coins are paid out, a control signal is transmitted to the hopper 66 to pay out a predetermined number of coins to the coin receiving portion 19.

Then, the main CPU determines whether a trigger symbol combination is formed or not (B8). The trigger symbol combination means a state where a predetermined number or more of the trigger symbols 180J are arranged in the symbol arrangement areas 151 to 155. When it is determined that a trigger symbol combination is not formed (B8: NO), this routine ends. On the other hand, when it is determined that a trigger symbol combination is formed (B8: YES), a feature game is run through the feature IN, based on the trigger symbol combination formed (B10). That is, when a trigger symbol combination includes the three or four trigger symbols 180J, a basic feature IN is formed. When five or more trigger symbols are arranged while being successively arranged in a row direction, a special feature IN is run. This routine ends thereafter.

(Process Routine of Slot Machine 1: Feature Game Running Process Routine)

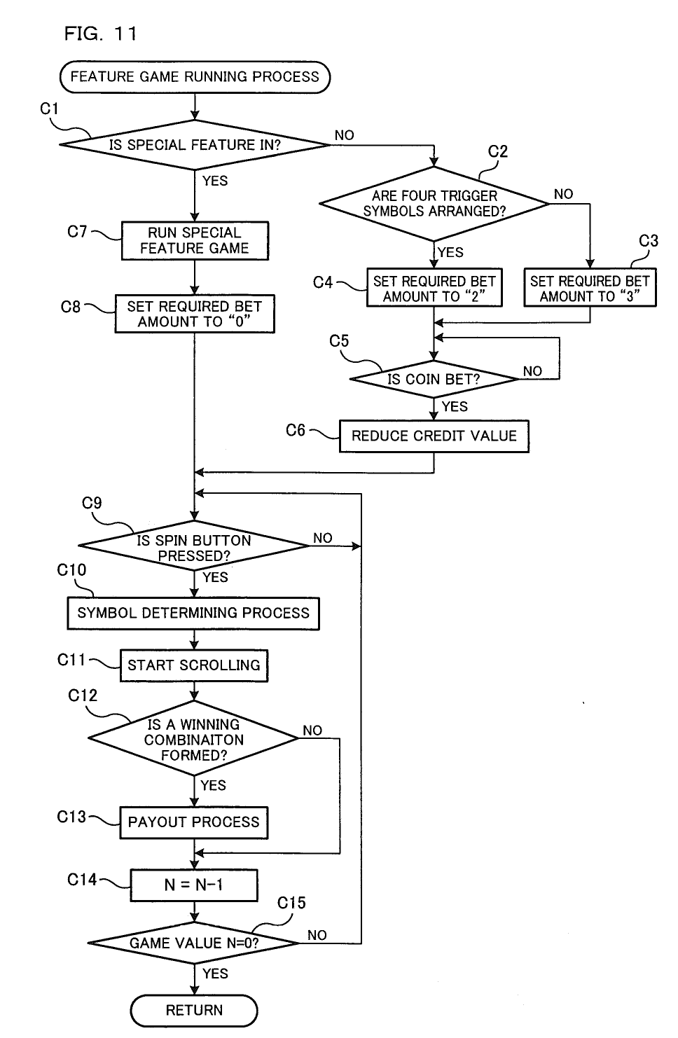

Next, after the basic game running process routine of FIG. 10, the main CPU 41 of the slot machine 1 executes a feature game running process routine of FIG. 11.

As shown in FIG. 11, in the feature game running process routine, the main CPU first determines whether the feature IN run in the basic game running process routine shown in FIG. 10 is a special feature IN or not (C1). When it is determined that the feature IN is not a special feature IN (C1: NO), the main CPU determines whether the trigger symbol combination formed is a trigger symbol combination of the four trigger symbols 180J (C2). When it is determined that the trigger symbol combination is not a trigger symbol combination of the four trigger symbols 180J (C2: NO), the main CPU sets the required bet amount to “3” (C3). On the other hand, when it is determined in C2 that the trigger symbol combination is a trigger symbol combination of the four trigger symbols 180J (C2: YES), the main CPU sets the required bet amount to “2” (C4). After setting the required bet amounts in C3 and C4, the main CPU determines whether a player bets a coin (C5). When it is determined that a coin is not bet (C5: NO), the main CPU stands by until a player bets a coin (C5). On the other hand, when it is determined that a coin is bet (C5: YES), the main CPU reduces the credit value stored in the RAM 43 according to the number of coins bet (C6).

On the other hand, when it is determined in C1 that the feature IN run in the basic game running process routine of FIG. 10 is a special feature IN (C1: YES), the main CPU runs a special feature game (C7) and sets the required bet amount to “0” (C8). In short, for the special feature game, a free game is set.

After the process C6 or C8, the main CPU determines whether the spin button is ON (pressed) (C9). When the spin button is not pressed (C3: NO), the main CPU stands by until a player presses the spin button.

On the other hand, when the spin button is pressed (C9: YES), the main CPU executes a symbol determining process (C10) and executes a scrolling process of scrolling the scatter symbols 180 in the central display 4B at the same time (C11)

Then, the main CPU determines whether the scatter symbols 180 rearranged on the symbol arrangement areas 151 to 155 form a winning combination (C12). When it is determined that a winning combination is not formed (C12: NO), the main CPU reduces the feature game value N by “1” (C14). On the other hand, when it is determined in C12 that a winning combination is formed (C12: YES), the main CPU executes a payout process (C13) and the process C14.

When the feature game value N is reduced by “1” in C14, the main CPU determines whether the feature game number N is “0” or not (C15). When it is determined that the bonus game value N is not “0” (C15: NO), the main CPU returns to C9. On the other hand, when it is determined that the feature game value N is “0” (C15: YES), this routine ends.

Through the basic game running process routine of FIG. 10 and the feature game running process routine of FIG. 11, when a predetermined number or more of the trigger symbols 180J, among the scatter symbols 180 rearranged in the symbol arrangement areas 151 to 155 of a matrix, are rearranged, a feature game is run. Further, the required bet amount of the feature game is set according to the number of the trigger symbols 180J rearranged. Hence, for example, the more the number of trigger symbols 180J, the less the required bet amount of the feature game. This removes the unfair reeling between a player who has more trigger symbols 180J rearranged and a player who has fewer trigger symbols 180J rearranged. Thus, a player is able to feel whether s/he is in a better/worse position compared to another player, in terms of bet amount. In addition to the gaming characteristic that the feature game is run while enjoying the basic game, it is possible to provide a player with the gaming characteristic that the required bet amount of the feature game run is changed.

In addition, through the basic game running process routine of FIG. 10 and the feature game running process routine of FIG. 11, when a specified number or more of the trigger symbols 180J are rearranged, the specified number being larger than the predetermined number, a feature game is run in which the required bet amount is set to 0. Hence, it is possible to enable a player to aim at a state in which the more trigger symbols 180J are arranged, so that the gaming characteristic is more improved.

In addition, through the basic game running process routine of FIG. 10 and the feature game running process routine of FIG. 11, when a predetermined number or more of the trigger symbols 180J are arranged while being successively arranged in a row direction of one row, a special feature game is run in which the required bet amount is set to 0. Hence, it is possible to enable a player to aim at a state in which the trigger symbols 180J are successively arranged in a row direction, so that the gaming characteristic is more improved.

(Process Routine of Slot Machine 1: Self Reset Process Routine)

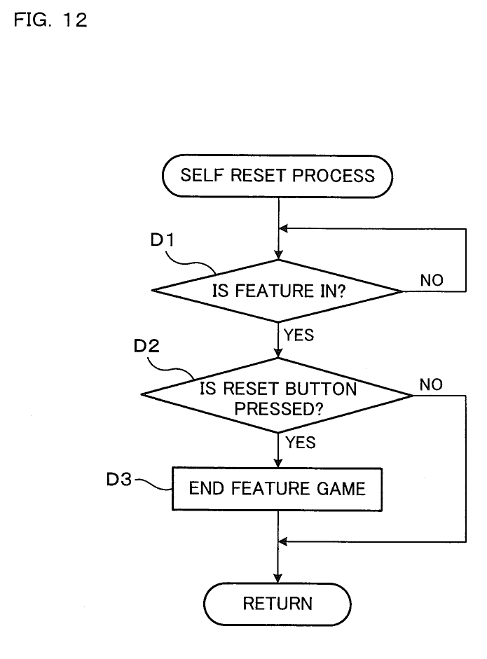

FIG. 12 is a flowchart showing a self reset process routine that is executed in the main CPU 41 of the slot machine 1. When a self reset process routine is executed, the main CPU 41 determines whether a feature IN is formed (D1). When a feature IN is not formed, i.e., when it is determined that a gaming state is a basic game state (D1: NO), the main CPU stands by until a feature IN is formed. On the other hand, when a feature IN is formed, i.e., when it is determined that a gaming state is a feature gaming state (D1: YES), the main CPU determines whether a player presses the reset button 310 (D2). When it is determined that the reset button is not pressed (D2: NO), the main CPU stands by until a player presses the reset button. On the other hand, when it is determined that the reset button is pressed (D2: YES), the main CPU ends the feature game that is being run (D3) and then this routine ends.

Through the self reset process routine of FIG. 12, when a player presses the reset button 310, the player can end the feature game run. Accordingly, the player is enabled to select whether to play the feature game based on his/her determination. This enables the player to select a game more freely.

(Process Routine of Slot Machine 1: Count Reset Process Routine)

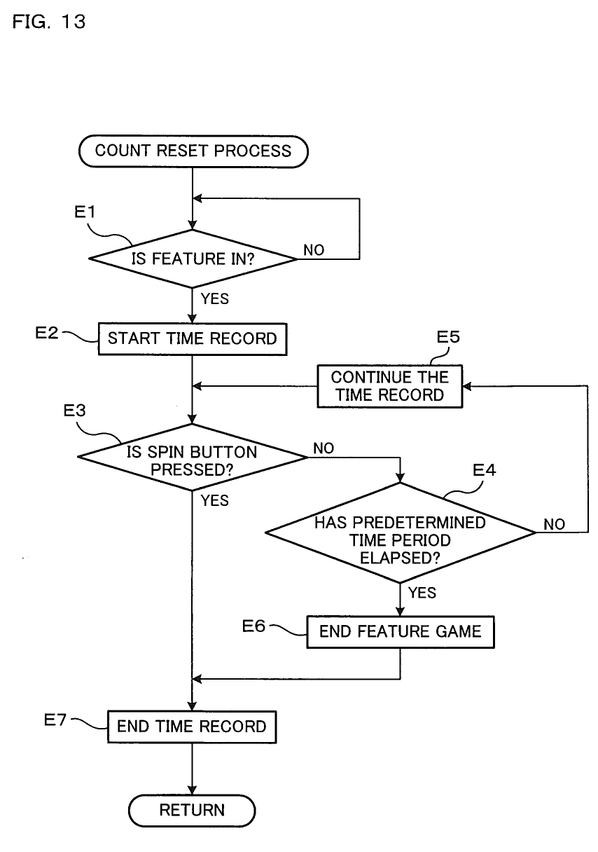

FIG. 13 is a flowchart showing a count reset process routine that is executed by the main CPU 41 of the slot machine 1. When a count reset process routine is executed, the main CPU 41 determines whether a feature IN is formed (E1). When a feature IN is not formed, i.e., when it is determined that a gaming state is a basic game state (E1: NO), the main CPU stands by until a feature IN is formed. On the other hand, when a feature IN is formed, i.e., when it is determined that a gaming state is a feature gaming state (E1: YES), the main CPU causes the count unit 123 to start timing (E2).

Then, the main CPU determines whether a player presses the spin button (E3). When it is determined that the spin button is not pressed (E3: NO), the main CPU determines whether a predetermined period of time has elapsed since the count unit 123 has started timing (E4). When it is determined that a predetermined period of time has not elapsed (E4: NO), the main CPU causes the count unit 123 to continue timing (E5). Afterwards, the main CPU stands by until a player presses the spin button (E3). On the other hand, when it is determined in E4 that a predetermined period of time since the count unit 123 has started timing (E4: YES), the main CPU ends the feature game that is being run (E6). Afterwards, the main CPU causes the count unit 123 to stop timing (E7) and ends this routine.

On the other hand, when it is determined in E3 that the spin button is pressed (E3: YES), the main CPU causes the count unit 123 to stop timing (E7) and ends this routine.

Through the count reset process routine of FIG. 13, the feature game can be ended without causing a player, who has not an intention to play the feature game, to play the feature game. Accordingly, the player is enabled to select whether to play the feature game based on his/her determination. This enables the player to select a game more freely. In addition, when a feature game is run, the game is prevented from being left alone without starting a game for a long time. Accordingly, it is possible to restrain another player, who has not made the feature IN for herself/himself, from playing the feature game from the beginning. Hence, it is possible to remove the unfair feeling between a player who has made the feature IN for herself/himself and a player who plays the feature game resulting from the feature IN made by another player.

(Process of Slot Machine 1: Player Change Reset Process Routine)

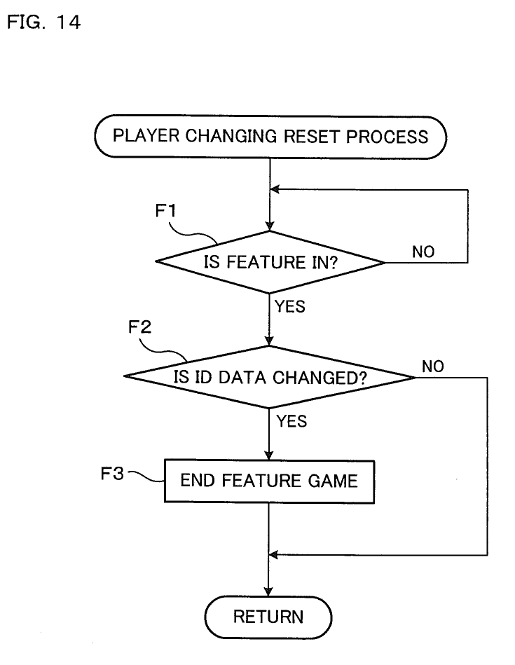

FIG. 14 is a flowchart showing a player changing reset process routine that is executed by the main CPU 41 of the slot machine 1. When a player changing reset process routine is executed, the main CPU 41 determines whether a feature IN is formed or not (F1). When a feature IN is not formed, i.e., when it is determined that a gaming state is a basic game state (F1: NO), the main CPU stands by until a feature IN is formed. On the other hand, when a feature IN is formed, i.e., when it is determined that a gaming state is a feature gaming state (F1: YES), the main CPU determines whether a new ID card 300 is inserted into the card reader 15 and the ID data is changed, i.e., whether a player who playing the feature game is changed (F2). When it is determined that the ID data is not changed (F2: NO), this routine ends.

On the other hand, when it is determined that the ID data is changed (F2: YES), the main CPU ends the feature game (F3) and ends this routine thereafter.

Through the player changing reset process routine of FIG. 14, it is possible to limit a player who plays a feature game, and to remove the unfair feeling between a player who has made the feature IN for herself/himself and a player who plays the feature game resulting from the feature IN made by another player.

In the present embodiment, the feature game includes the basic feature game and the special feature game. However, the invention is not limited thereto. For example, more kinds of feature games may be possible.

Further, in the present embodiment, the condition of setting the required bet amount in the feature game is as follows: when the three trigger symbols 180J are arranged, the required bet amount is “3 credits,” when the four trigger symbols 180J are arranged, the required bet amount is “2 credits” and when the five or more or three or more trigger symbols 180J are arranged while being successively arranged in a row direction, the required bet amount is “0 credit.” However, the invention is not limited to such condition. In the present invention, when the number of the trigger symbols 180J arranged or the required bet amount in the arrangement state is changed, it may be set that the number of trigger symbols 180J is 6 or more and the required bet amount is “0 credit.”

The detailed description of the present invention provided hereinabove mainly focused on characteristics thereof for the purpose of easier understanding; however, the scope of the present invention shall be construed as broadly as possible, encompassing various forms of other possible embodiments, and therefore the present invention shall not be limited to the above description. Further, the terms and phraseology used in the present specification are adopted solely to provide specific illustration of the present invention, and in no case should the scope of the present invention be limited by such terms and phraseology. Further, it will be obvious for those skilled in the art that the other structures, systems, methods or the like are possible, within the spirit of the invention described in the present specification. The description of claims therefore shall encompass structures equivalent to the present invention, unless otherwise such structures are regarded as to depart from the spirit and scope of the present invention. Further, the abstract is provided to allow, through a simple investigation, quick analysis of the technical features and essences of the present invention by an intellectual property office, a general public institution, or one skilled in the art who is not fully familiarized with patent and legal or professional terminology. It is therefore not an intention of the abstract to limit the scope of the present invention which shall be construed on the basis of the description of the claims. To fully understand the object and effects of the present invention, it is strongly encouraged to sufficiently refer to disclosures of documents already made available.

The detailed description of the present invention provided hereinabove includes a process executed on a computer or computer network. The above descriptions and expressions are provided to allow the one skilled in the art to most efficiently understand the present invention. A process performed in or by respective steps yielding one result or blocks with a predetermined processing function described in the present specification shall be understood as a process with no self-contradiction. Further, the electrical or magnetic signal is transmitted/received and written in the respective steps or blocks. It should be noted that such a signal is expressed in the form of bit, value, symbol, text, terms, number, or the like solely for the sake of convenience. Although the present specification occasionally personifies the processes performed in the steps or blocks, these processes are essentially executed by various devices. Further, the other structures necessary for the steps or blocks are obvious from the above descriptions.

What is claimed is:

1. A slot machine comprising:
a base game offering a chance of winning a payout according to a predetermined combination;
a special game offering a chance of winning a higher payout than the base game;
a bet unit that receives a bet by a player;
a display that has an arrangement area of a matrix of one or more rows and one or more columns and arranges one or more scatter symbols in the arrangement area; and
a game controller which performs the steps of:
(a1) rearranging the one or more scatter symbols in the arrangement area during the base game;
(a2) awarding a payout according to the number of scatter symbols rearranged;
(a3) running the special game when a predetermined number or more of specific scatter symbols, among the rearranged scatter symbols, are rearranged; and
(a4) setting a required bet amount of the special game run, according to the number of the specific scatter symbols rearranged.

2. The slot machine according to claim 1, wherein
the game controller runs the special game in which the required bet amount is set to zero, when a specified number or more of the specific scatter symbols are rearranged, the specified number being larger than the predetermined number.

3. The slot machine according to claim 1, wherein
the game controller runs the special game in which the required bet amount is set to zero, when the predetermined number or more of the specific scatter symbols are rearranged while being successively rearranged in one row in a row direction.

4. The slot machine according to claim 1, further comprising
a reset button that ends the special game run, wherein
the game controller ends the special game when the reset button is pressed.

5. A slot machine comprising:
a base game offering a chance of winning a payout according to a predetermined combination;
a special game offering a chance of winning a higher payout than the base game;
a bet unit that receives a bet by a player;
a display that has an arrangement area of a matrix of one or more rows and one or more columns and arranges one or more scatter symbols in the arrangement area;
a reset button that ends the special game run; and
a game controller which performs the steps of:
(b1) rearranging the one or more scatter symbols in the arrangement area during the base game;
(b2) awarding a payout according to the number of scatter symbols rearranged;
(b3) running the special game when a predetermined number or more of specific scatter symbols, among the rearranged scatter symbols, are rearranged;
(b4) setting a required bet amount of the special game run, according to the number of the specific scatter symbols rearranged;
(b5) setting the required bet amount to zero, when a specified number or more of the specific scatter symbols are rearranged, the specified number being larger than the predetermined number, or when the predetermined number or more of the specific scatter symbols are rearranged while being successively rearranged in a row direction of one row; and
(b6) ending the special game run, when the reset button is pressed.

6. A playing method of a slot machine, which machine includes a base game offering a chance of winning a payout according to a predetermined combination; a special game offering a chance of winning a higher payout than the base game; a bet unit that receives a bet by a player; and a display that has an arrangement area having a matrix of one or more rows and one or more columns and arranges one or more scatter symbols in the arrangement area,
the method comprising the steps of:
(c1) rearranging the one or more scatter symbols in the arrangement area during the base game;
(c2) awarding a payout according to the number of scatter symbols rearranged;
(c3) running the special game when a predetermined number or more of specific scatter symbols, among the rearranged scatter symbols, are rearranged; and
(c4) setting a required bet amount of the special game run, according to the number of the specific scatter symbols rearranged.
